(19) United States
(12) Patent Application Publication
(10) Pub. No.: US 2019/0310566 A1
(43) Pub. Date: Oct. 10, 2019

(54) OPTICAL WRITING DEVICE AND IMAGE FORMING

(71) Applicant: KONICA MINOLTA, INC., Tokyo (JP)

(72) Inventors: Takahiro MATSUO, Toyokawa-shi (JP); Atsushi NAGAOKA, Okazaki-shi (JP); Masahiko TAKAHASHI, Tokyo (JP)

(21) Appl. No.: 16/298,882

(22) Filed: Mar. 11, 2019

(30) Foreign Application Priority Data
Apr. 9, 2018 (JP) 2018-074728

(51) Int. Cl. G03G 15/04; G03G 15/043; G02B 27/30; G03G 15/00

(52) U.S. Cl. CPC G03G 15/04054; G03G 15/0435; G03G 2215/0409; G03G 15/80; G03G 2215/0412; G02B 27/30

(57) ABSTRACT

An optical writing device includes: a light source substrate in which a plurality of light sources and a driving circuit for driving the plurality of light sources are mounted on the same substrate surface; and an optical element that images outgoing light of the light sources on a photoreceptor, wherein the plurality of light sources are two-dimensionally disposed in plan view from an optical axis direction of the optical element, and the light sources having distances different from each other in the optical axis direction to the photoreceptor are included.

The entire disclosure of Japanese patent Application No. 2018-074728, filed on Apr. 9, 2018, is incorporated herein by reference in its entirety.

### BACKGROUND

### Technological Field

The present invention relates to an optical writing device and an image forming apparatus, and in particular, to a technique for achieving both high definition and downsizing of a line optical type optical writing device.

### Description of the Related Art

In the technical field of an electrophotographic image forming apparatus, there are provided two kinds of an optical scanning type optical writing device and a line optical type optical writing device, that expose photoreceptors to form an electrostatic latent image. Among them, since it is easy to downsize the line optical type optical writing device as compared with the optical scanning type optical writing device, the line optical type optical writing device is remarkably popular in recent years.

However, downsizing on the image forming apparatus is required continuously, and further downsizing on the line optical type optical writing device is also required. In particular, since the line optical type optical writing device needs to be disposed in the immediate vicinity of a photosensitive drum, there is severe restriction on the size in a sub-scanning direction.

On the other hand, when the number of light emitting points of the line optical type optical writing device is increased according to the high definition of an image, a driver integrated circuit (IC) for driving and controlling the light emitting points and the number of wirings for power supply are increased, so that the size of a light source substrate is increased.

For example, as illustrated in FIG. 10, in a case where a light emitting region, in which a light emitting point group including a plurality of the light emitting points are disposed in a zigzag manner along a main scanning direction, is provided in the central portion of the light source substrate in the sub-scanning direction, and the driver IC is disposed adjacent to the light emitting region in the sub-scanning direction in order to shorten the length of wirings for driving and controlling the light emitting points, an anisotropic conductive film (ACF) connection space for connecting, to the light source substrate, a flexible printed circuit (FPC) for inputting image data and the like to the driver IC needs to be provided in the end portion of the light source substrate in the sub-scanning direction. Then, it is inevitable to increase the size of the light source substrate in the sub-scanning direction.

To deal with such a problem, in a light source substrate of the related art, on which a light emitting diode (LED) is mounted on a glass epoxy substrate, for example, as illustrated in FIG. 11, it is possible to downsize a light source substrate 1102 in the sub-scanning direction, in a case where an LED 1101 and a driver IC 1103 are mounted on the main surface on sides opposite to each other of the light source substrate 1102 by using the light source substrate 1102 obtained by multilayering the glass epoxy substrate, as compared with a case where the LED 1101 and the driver IC 1103 are mounted on the same main surface of the light source substrate 1102.

Also, as illustrated in FIG. 12, it is possible to downsize a light source substrate 1202 in the sub-scanning direction, in a case where an LED 1201 and a driver IC 1203 are respectively mounted on one substrate surface of light source substrates 1202 and 1212 different from each other, connectors 1204 and 1205 are respectively mounted on the other substrate surface of the light source substrates 1202 and 1212, and a harnesse 1206 is used for connecting the connectors 1204 and 1205 such that circuits formed on the light source substrates 1202 and 1212 are electrically connected, as compared with a case where the LED 1201 and the driver IC 1203 are mounted on the same main surface of the light source substrate 1202, as well.

Patent Literature 1: JP 2009-36854 A

Patent Literature 2: JP 2007-206668 A

In recent years, a light source substrate using an Organic LED (OLED), which may be formed by the same process as a thin film transistor (TFT) circuit, as a light emitting point has attracted attention. The OLED is an organic electro-luminescence (EL) element formed by laminating an anode including a transparent electrode such as indium oxide (ITO) on a transparent glass substrate, an organic layer including at least one layer on the anode, and a cathode including an electrode such as aluminum on the organic layer.

Since this OLED is formed on a glass substrate and difficult to be multilayered, as illustrated in FIG. 13, there is no choice but to dispose an OLED 1301 and a driver IC 1303 on the same main surface of a glass substrate 1302, so that it is not possible to mount the driver IC 1303 on the back surface side of the OLED 1301. Therefore, it is not possible to downsize the glass substrate 1302 in the sub-scanning direction.

Also, even if an OLED and a connector are provided on different substrates, as illustrated in FIG. 14, there is no choice but to dispose an OLED 1401 and a connector 1404 on the same main surface of a glass substrate 1402 and dispose a driver IC 1403 and a connector 1405 on the same main surface of a glass substrate 1412, so that there is a limit to the downsizing of the glass substrates 1402 and 1412 in the sub-scanning direction, as well.

### SUMMARY

The present invention has been made in view of the above-described problems, and an object of the present invention is to provide an optical writing device and an image forming apparatus capable of achieving both high definition of an image and reduction of unit size in the sub-scanning direction.

To achieve the abovementioned object, according to an aspect of the present invention, an optical writing device reflecting one aspect of the present invention comprises: a light source substrate in which a plurality of light sources and a driving circuit for driving the plurality of light sources are mounted on the same substrate surface; and an optical element that images outgoing light of the light sources on a photoreceptor, wherein the plurality of light sources are two-dimensionally disposed in plan view from an optical axis direction of the optical element, and the light sources having distances different from each other in the optical axis direction to the photoreceptor are included.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating a main configuration of an image forming apparatus according to a first embodiment of the present invention;

FIG. 2 is a sectional view illustrating a main configuration of an optical writing device according to the first embodiment of the present invention;

FIG. 3 is a sectional view illustrating a main configuration of an optical writing device according to a second embodiment of the present invention;

FIG. 4A is a plan view illustrating the disposition of a light emitting element group in a light source substrate according to the second embodiment of the present invention;

FIG. 4B is a plan view illustrating the disposition of light emitting points in one light emitting element group;

FIG. 5 is a sectional view illustrating a configuration of an optical element according to the second embodiment of the present invention;

FIG. 6 is a sectional view illustrating a main configuration of an optical writing device according to a third embodiment of the present invention;

FIG. 7 is a sectional view illustrating a main configuration of an optical writing device according to a fourth embodiment of the present invention;

FIG. 8 is a sectional view illustrating another configuration example of the optical writing device according to the fourth embodiment of the present invention;

FIG. 9 is a sectional view illustrating a main configuration of an optical writing device according to a fifth embodiment of the present invention;

FIG. 10 is a plan view illustrating a main configuration of a light source substrate according to a technique of the related art;

FIG. 11 is a view illustrating a light source substrate in which an LED and a driver IC are mounted on both sides of a glass epoxy substrate;

FIG. 12 is a view illustrating a light source substrate in which an LED and a driver IC are mounted on glass epoxy substrates different from each other;

FIG. 13 is a view illustrating a light source substrate in which an OLED and a driver IC are mounted on a glass substrate; and

FIG. 14 is a view illustrating a light source substrate in which an OLED and a driver IC are mounted on glass substrates different from each other.

### DETAILED DESCRIPTION OF EMBODIMENTS

Hereinafter, one or more embodiments of an optical writing device and an image forming apparatus according to the present invention will be described with reference to the drawings. However, the scope of the invention is not limited to the disclosed embodiments.

### [1] First Embodiment

An image forming apparatus according to the present embodiment is characterized in that OLEDs are disposed on both surfaces of a light source substrate.

### (1-1) Configuration of Image Forming Apparatus

First, the configuration of the image forming apparatus according to the present embodiment will be described.

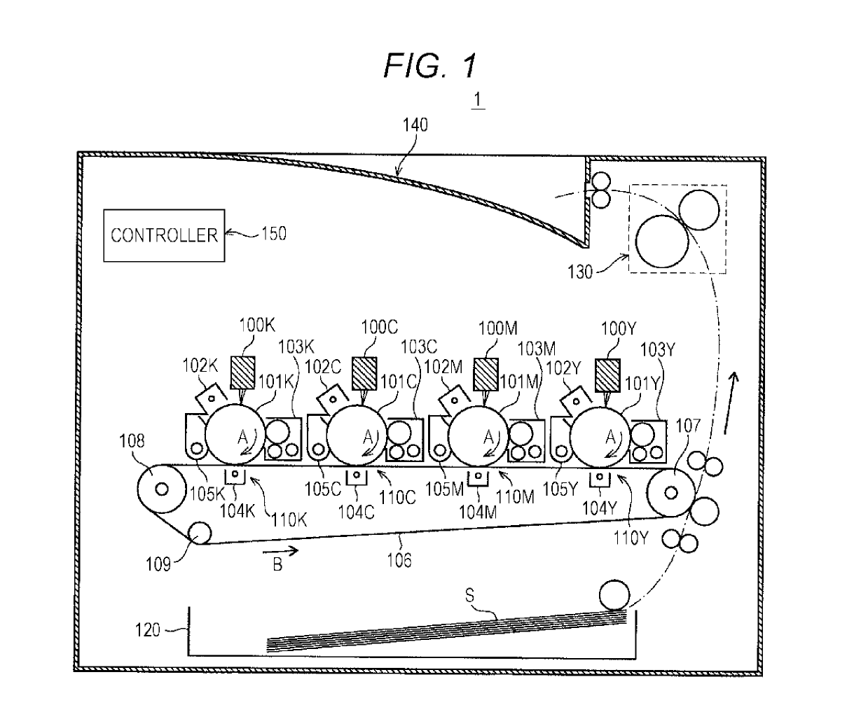

As illustrated in FIG. 1, an image forming apparatus 1 is a so-called tandem type color printer, and has image formers 110Y, 110M, 110C and 110K that form toner images of respective colors of yellow (Y), magenta (M), cyan (C) and black (K). The image formers 110Y, 110M, 110C, and 110K have photosensitive drums 101Y, 101M, 101C, and 101K for rotating in a direction of an arrow A.

Charging devices 102Y, 102M, 102C and 102K, optical writing devices 100Y, 100M, 100C and 100K, developing devices 103Y, 103M, 103C and 103K, primary transfer rollers 104Y, 104M, 104C and 104K and cleaning devices 105Y, 105M, 105C and 105K are disposed in order along the outer peripheral surface on the periphery of the photosensitive drums 101Y, 101M, 101C and 101K.

The charging devices 102Y, 102M, 102C, and 102K uniformly charge the outer peripheral surfaces of the photosensitive drums 101Y, 101M, 101C, and 101K. The optical writing devices 100Y, 100M, 100C and 100K are a so-called organic light emitting diode-print head (OLED-PH) that exposes the outer peripheral surfaces of the photosensitive drums 101Y, 101M, 101C and 101K to form electrostatic latent images.

The developing devices 103Y, 103M, 103C, and 103K supply toners of respective colors of Y, M, C, and K to develop electrostatic latent images, so that toner images of respective colors of Y, M, C, and K are formed.

The primary transfer rollers 104Y, 104M, 104C and 104K electrostatically transfer the toner images carried on the photosensitive drums 101Y, 101M, 101C and 101K to an intermediate transfer belt 106 (primary transfer).

The cleaning devices 105Y, 105M, 105C, and 105K remove charges remaining on the outer peripheral surfaces of the photosensitive drums 101Y, 101M, 101C, and 101K after the primary transfer, and remove remaining toners. Incidentally, hereinafter, in the description of configurations common to the image formers 110Y, 110M, 110C, and 110K, letters Y, M, C, and K are skipped.

The intermediate transfer belt 106 is an endless belt that is tensioned and laid between a pair of secondary transfer rollers 107 and on the driven rollers 108 and 109, and that rotatively runs in the direction of an arrow B. Since the primary transfer is performed in accordance with such rotation and running, the toner images of respective colors of Y, M, C, and K are superimposed on one another to form a color toner image. The intermediate transfer belt 106 rotatively runs in a state of carrying the color toner image, thereby transporting the color toner image to a secondary transfer nip between a pair of the secondary transfer rollers 107.

Two rollers forming a pair of the secondary transfer rollers 107 are pressed against each other, thereby forming the secondary transfer nip. A secondary transfer voltage is applied between these rollers. Once the intermediate transfer belt 106 supplies a recording sheet S from a sheet feeding tray 120 in accordance with a timing of transporting the color toner image, the color toner image is electrostatically transferred to the recording sheet S at the secondary transfer nip (secondary transfer).

The recording sheet S is transported to a fixing apparatus 130 in a state of carrying the color toner image, and is discharged to a discharge tray 140 after the color toner image is thermally fixed.

The image forming apparatus 1 further has a controller 150. Once the controller 150 receives a print job from an external apparatus such as a personal computer (PC), the controller controls the operations of the image forming apparatus 1 to execute image formation.

### (1-2) Configuration of Optical Writing Device 100

Next, the configuration of the optical writing device 100 will be described.

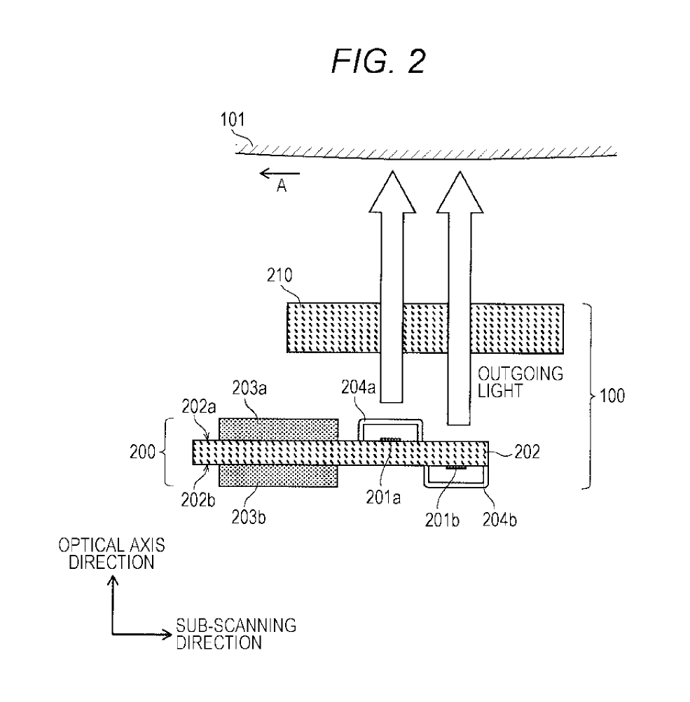

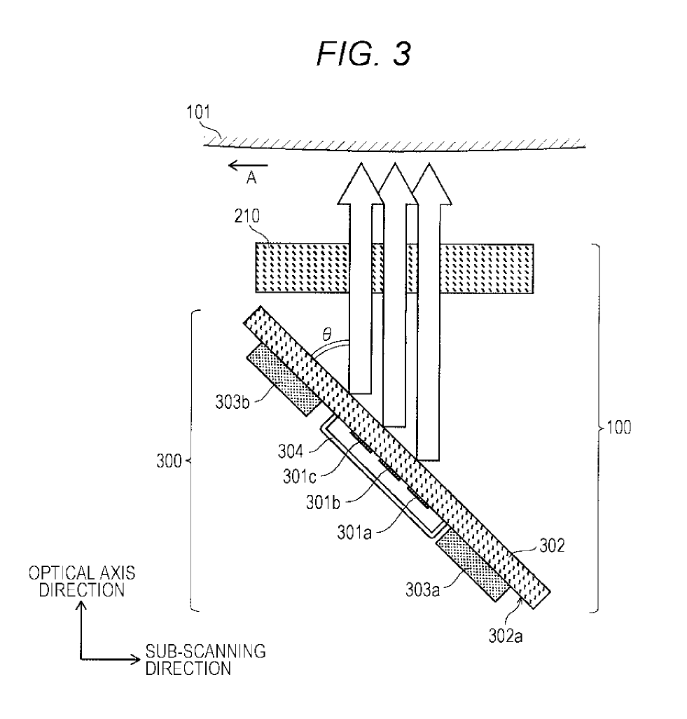

As illustrated in FIG. 2, the optical writing device 100 has a light source substrate 200 and an optical element 210, and a holder (not illustrated) supports the light source substrate 200 and the optical element 210. The optical element 210 is, for example, a micro lens array (MLA), and images the outgoing light of the light source substrate 200 on the outer peripheral surface of a photosensitive drum 101.

In the light source substrate 200, a light emitting point group 201a and a driver IC 203a are mounted on a substrate surface 202a of a glass substrate 202 opposite to the optical element 210, and a light emitting point group 201b and a driver IC 203b are mounted on a substrate surface 202b on the back side of the substrate surface 202a. All the light emitting point groups 201a and 201b include a plurality of light emitting points, and all the light emitting points are OLEDs.

The light emitting point groups 201a and 201b are disposed at positions different from each other in the sub-scanning direction, are all disposed in a plurality of arrays along the main scanning direction (a direction orthogonal to both an optical axis direction and the sub-scanning direction), and are respectively sealed by sealing glasses 204a and 204b in order not to be in contact with outside air. Also, a distance in the optical axis direction from the light emitting point group 201a to the photosensitive drum 101 is shorter than a distance in the optical axis direction from the light emitting point group 201b to the photosensitive drum 101.

In the light source substrate 200, the number of light emitting point groups per one substrate surface is reduced, as compared with a light source substrate in which light emitting point groups are disposed only on one substrate surface. Therefore, the scale of the driver IC mounted on one substrate surface is also small, as compared with the light source substrate in which the light emitting point groups are disposed only on one substrate surface.

Furthermore, in the light source substrate in which the light emitting point groups are disposed only on one substrate surface, all the driver ICs have to be disposed at positions different from each other in plan view from the optical axis direction, whereas in the present embodiment, the driver ICs 203a and 203b are disposed to overlap each other at positions corresponding to each other on the substrate surfaces 202a and 202b in plan view from the optical axis direction. Therefore, since it is possible to reduce the area of the glass substrate 202, it is possible to downsize the light source substrate 200.

### [2] Second Embodiment

The image forming apparatus according to the present embodiment has substantially the same configurations as those of the image forming apparatus 1 according to the first embodiment, but has a different configuration of the optical writing device 100. Hereinafter, the description of the difference, on which focus is mainly, will be provided.

In a light source substrate 300 of the optical writing device 100 according to the present embodiment, light emitting point groups 301a, 301b, and 301c, and driver ICs 303a and 303b are mounted on one substrate surface 302a of a glass substrate 302, and the light emitting point groups 301a, 301b, and 301c are sealed by a sealing glass 304. A holder (not illustrated) holds the optical element 210 and the glass substrate 302 such that the substrate surface of the glass substrate 302 is at a predetermined inclination angle of θ to the optical axis direction of the optical element 210. In this way, it is possible to reduce the size of the light source substrate 300 in the sub-scanning direction in a plan view from the optical axis direction, without reducing substrate area of the light source substrate 300.

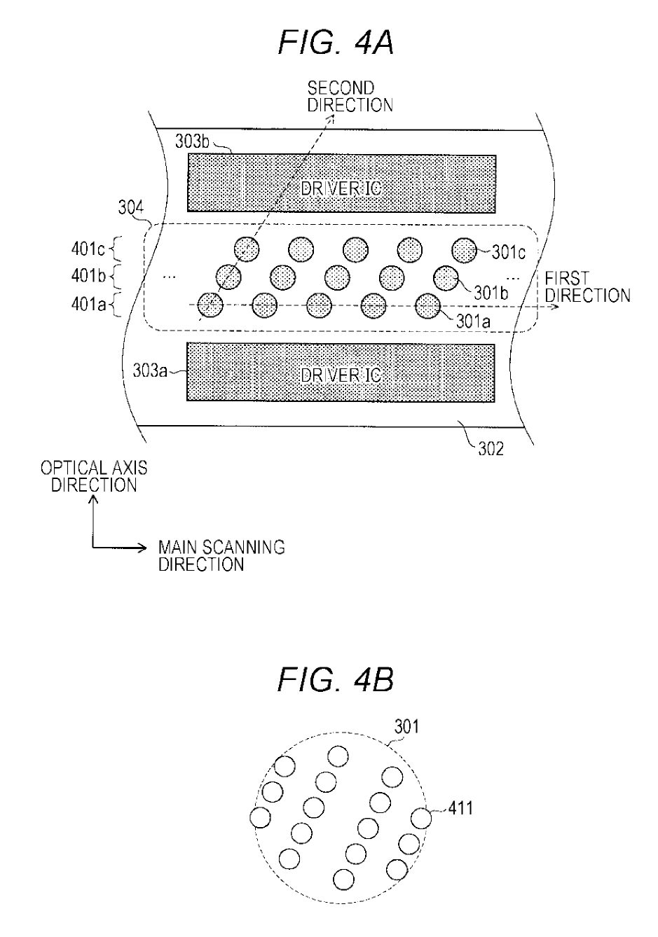

As illustrated in FIGS. 4A and 4B, the light emitting point groups 301a, 301b, and 301c, respectively, belong to light emitting element group arrays 401a, 401b, and 401c obtained by disposing the light emitting element groups along the main scanning direction. Distances in the optical axis direction from the light emitting element group arrays 401a, 401b, and 401c to the outer peripheral surface of the photosensitive drum 101 are different for each light emitting element group array, and light emitting element groups belonging to the same light emitting element group array have the same distance in the optical axis direction to the outer peripheral surface of the photosensitive drum 101.

In the present embodiment, in a case where a micro lens array is used as the optical element 210, it is possible to perform imaging on the outer peripheral surface of the photosensitive drum 101 by using a separate micro lens for each light emitting point group, so that it is possible to downsize the light source substrate 300 without affecting imaging performance on the outer peripheral surface of the photosensitive drum 101 even if the distances to the outer peripheral surface of the photosensitive drum 101 are different for each light emitting point group.

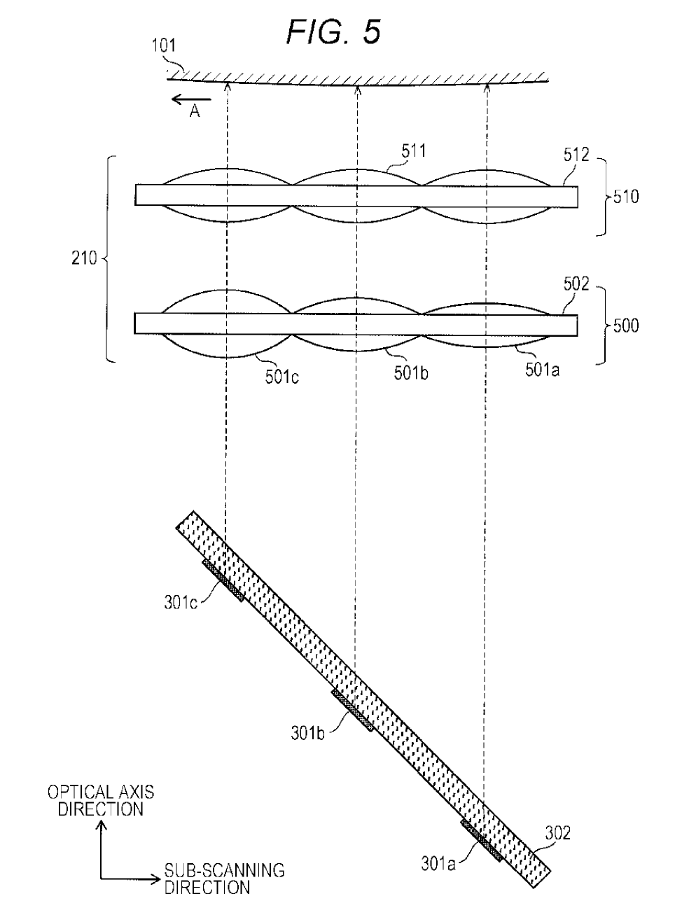

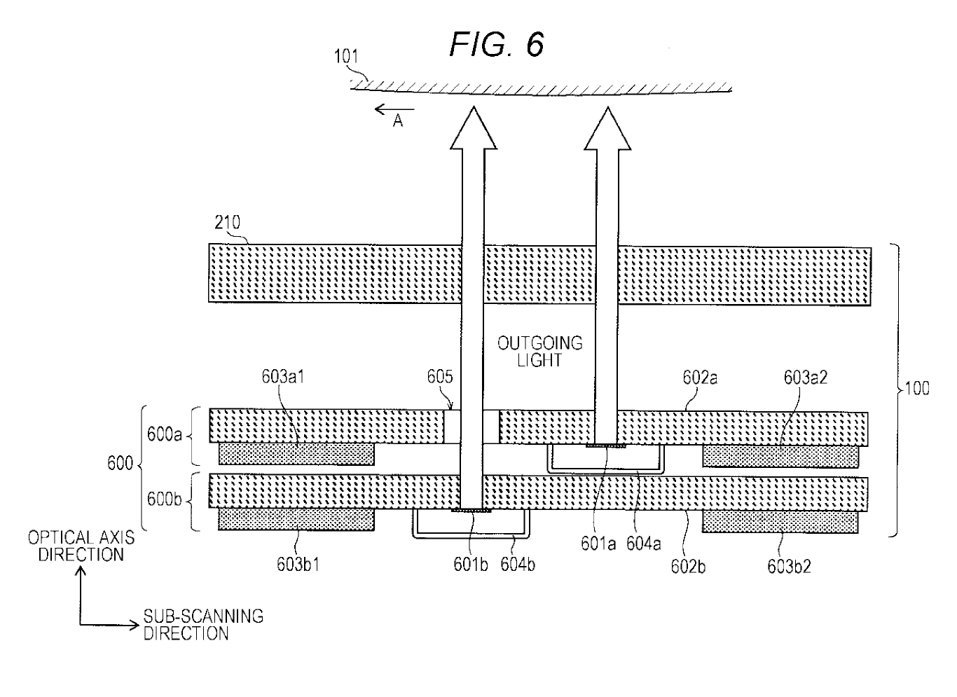

As illustrated in FIG. 5, the optical element 210 includes a micro lens array 500 for collimating the outgoing light of the light source substrate 300 and a micro lens array 510 for performing imaging on the outer peripheral surface of the photosensitive drum 101. The micro lens array 500 is obtained by forming resin lenses 501a, 501b, and 501c on a glass substrate 502.

The resin lenses 501a, 501b, and 501c correspond to the light emitting point groups 301a, 301b, and 301c, respectively, and collimate the outgoing light of the light emitting point groups 301a, 301b, and 301c. Therefore, the resin lenses 501a, 501b, and 501c are different from one another.

Also, the micro lens array 510 is obtained by forming resin lenses 511 on a glass substrate 512. Since collimated light is also incident on all of the resin lenses 511 and distances from the resin lenses 511 to the outer peripheral surface of the photosensitive drum 101 are the same as one another, the resin lenses 511 are the same lenses as one another. Incidentally, the resin lenses 501a, 501b, 501c, and 511 have the same resin lenses provided in an array along the main scanning direction.

Also, a second direction obtained by connecting the centers of the light emitting element groups positioned at one end in the main scanning direction of the light emitting element group arrays 401a, 401b, and 401c, obliquely intersects a first direction (the main scanning direction), but may be orthogonal to the first direction.

### [3] Third Embodiment

The image forming apparatus according to the present embodiment has substantially the same configurations as those of the image forming apparatus 1 according to the first embodiment, but has a different configuration of the optical writing device 100. Hereinafter, the description of the difference, on which focus is mainly, will be provided.

A light source substrate 600 according to the present embodiment includes two unit substrates 600a and 600b, and the unit substrates 600a and 600b have substantially the same configurations. That is, in all of the unit substrates 600a and 600b, light emitting point groups 601a and 601b, and driver ICs 603a1, 603a2, 603b1 and 603b2 are mounted on the substrate surface opposite to the optical element 210 in the optical axis direction of glass substrates 602a and 602b, and the light emitting point groups 601a and 601b are respectively sealed by the sealing glasses 604a and 604b.

A upper portion of the sealing glass 604a of the unit substrate 600a is flat, and this flat upper portion is adhesively fixed to the substrate surface on the optical element 210 side in the optical axis direction of the unit substrate 600b.

Also, the glass substrate 602a of the unit substrate 600a is provided with a through hole 605 through which the outgoing light of the light emitting point group 601b mounted on the unit substrate 600b is allowed to pass in a state where the unit substrates 600a and 600b are adhesively fixed to overlap in the optical axis direction.

Incidentally, instead of the through hole 605, the corresponding position of the glass substrate 602a may be a transparent portion.

In this way, since it is possible to simulatively multilayer the light source substrate 600, the driver ICs 603a1 and 603b1 may be disposed to overlap each other, and the driver ICs 603a2 and 603b2 may be disposed to overlap each other, when viewed from the optical axis direction. Therefore, it is possible to reduce the size of the light source substrate 600 in the sub-scanning direction.

### [4] Fourth Embodiment

The image forming apparatus according to the present embodiment has substantially the same configurations as those of the image forming apparatus 1 according to the first embodiment, but has a different configuration of the optical writing device 100. Hereinafter, the description of the difference, on which focus is mainly, will be provided.

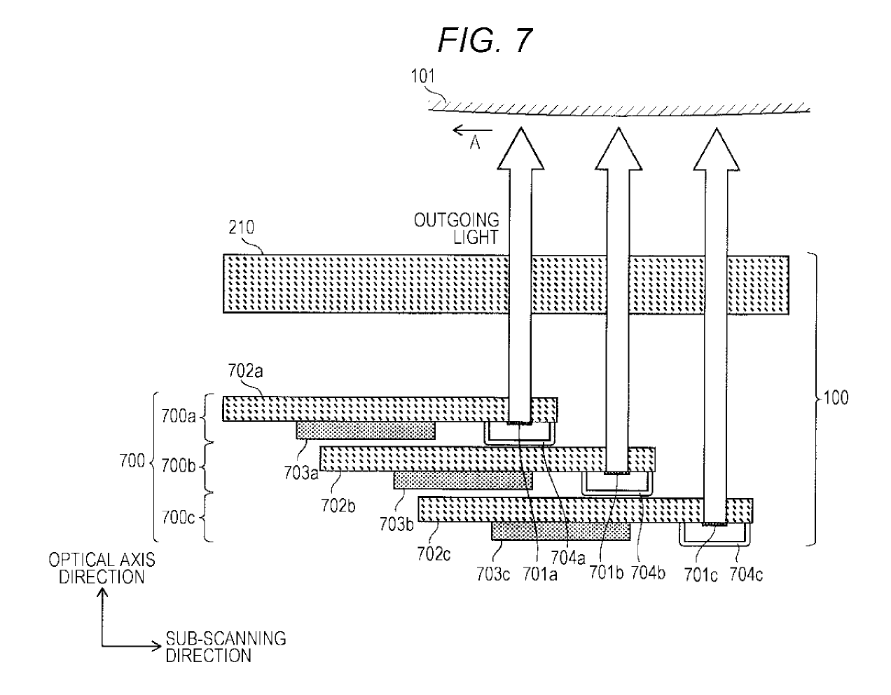

As illustrated in FIG. 7, a light source substrate 700 according to the present embodiment includes three unit substrates 700a, 700b, and 700c having the same configurations. That is, in all of the unit substrates 700a, 700b, and 700c, light emitting point groups 701a, 701b, and 701c, and driver ICs 703a, 703b, and 703c are mounted on the substrate surface opposite to the optical element 210 in the optical axis direction of glass substrates 702a, 702b, and 702c, and the light emitting point groups 701a, 701b, and 701c are respectively sealed by sealing glasses 704a, 704b, and 704c.

The unit substrates 700a, 700b, and 700c are disposed at the same position in the main scanning direction, but are shifted by a predetermined length in the sub-scanning direction. Also, the upper portions of the sealing glasses 704a and 704b of the unit substrates 700a and 700b are flat, and these flat upper portions are adhesively fixed to the substrate surfaces on the optical element 210 side in the optical axis direction of the unit substrates 700b and 700c.

In this way, unlike the third embodiment, even if through holes or transparent portions are not provided in the unit substrates 700a and 700b positioned on the optical element 210 side, it is possible to direct the outgoing light of the unit substrates 700b and 700c to the optical element 210. Also, since it is possible to simulatively multilayer the light source substrate 700, the driver ICs 703a, 703b, and 703c may be disposed to overlap one another, when viewed from the optical axis direction. Therefore, it is possible to reduce the size of the light source substrate 700 in the sub-scanning direction.

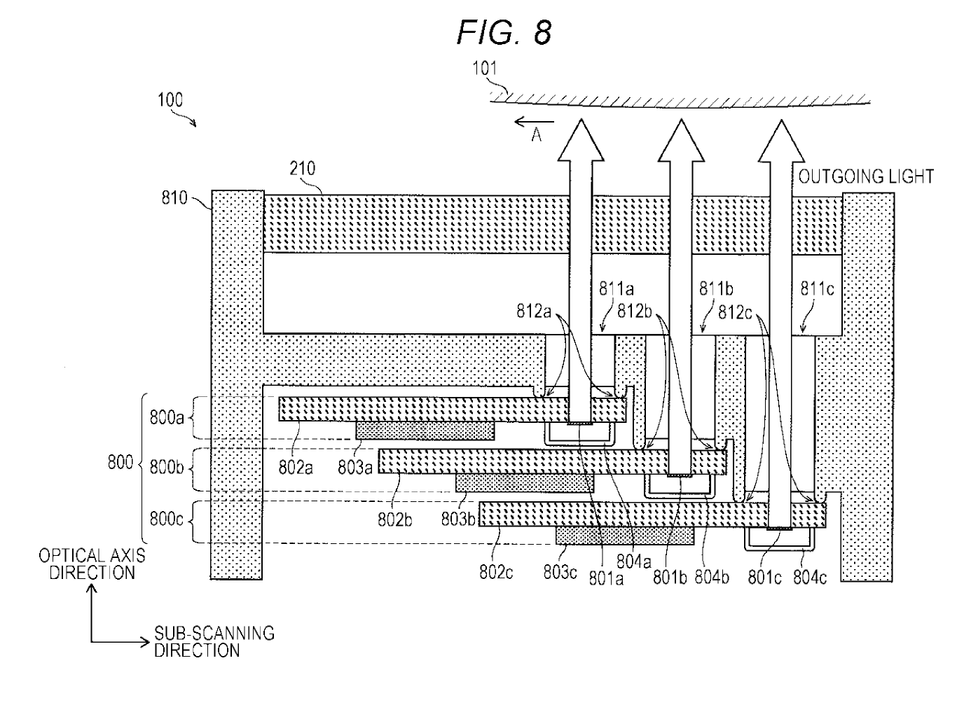

Incidentally, instead of adhesively fixing the substrate surfaces on the optical element 210 side in the optical axis direction of the unit substrates 700b and 700c, to the flat upper portions of the sealing glasses 704a and 704b of the unit substrates 700a and 700b, it is also possible to perform operations as follows. That is, as illustrated in FIG. 8, a holder 810 may be used to hold unit substrates 800a, 800b, and 800c, and the optical element 210. All the unit substrates 800a, 800b, and 800c have the same configurations as the unit substrates 700a, 700b, and 700c.

The holder 810 is provided with through holes 811a, 811b, and 811c through which the outgoing light of the unit substrates 800a, 800b, and 800c is allowed to pass, and protrusions 812a, 812b and 812c are provided on the peripheral edge opposite to the optical element 210 in the optical axis direction of the through holes 811a, 811b, and 811c. The protrusions 812a, 812b, and 812c are provided for positioning the unit substrates 800a, 800b, and 800c against the optical element 210. In this way, it is possible to accurately position the unit substrates 800a, 800b and 800c regardless of the heights of sealing glasses 804a, 804b and 804c.

### [5] Fifth Embodiment

The image forming apparatus according to the present embodiment has substantially the same configurations as those of the image forming apparatus 1 according to the first embodiment, but has a different configuration of the optical writing device 100. Hereinafter, the description of the difference, on which focus is mainly, will be provided.

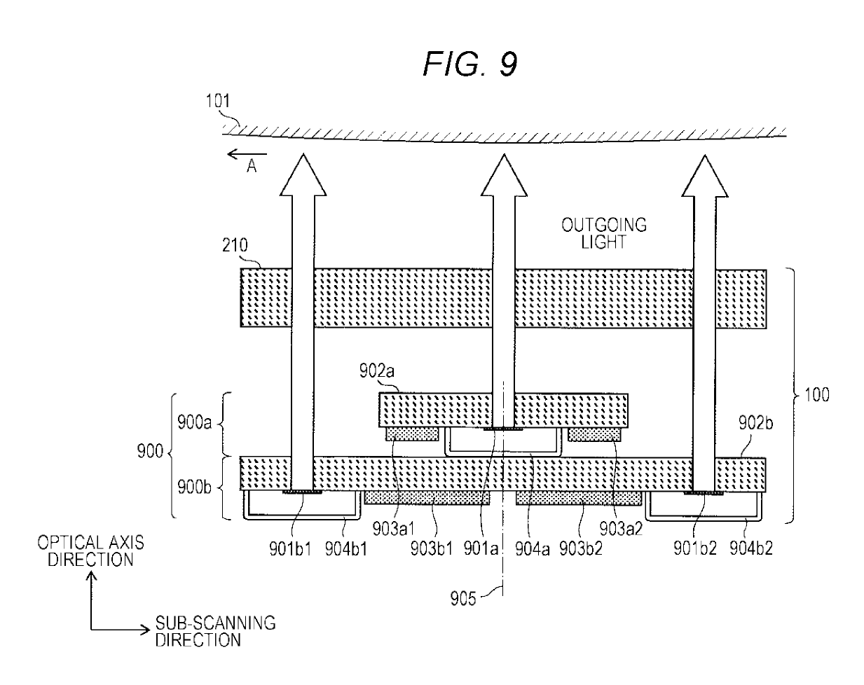

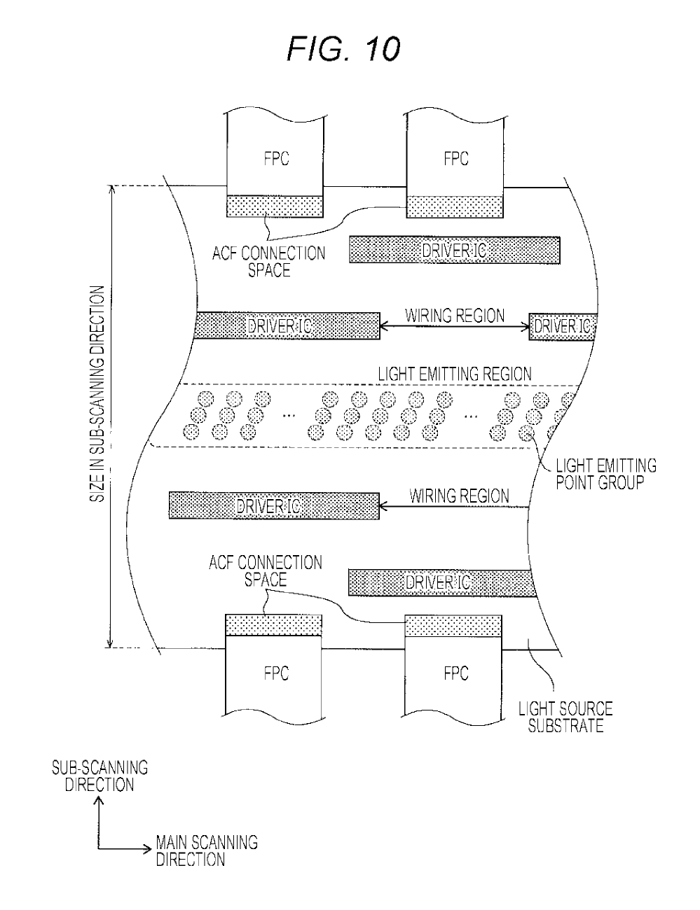

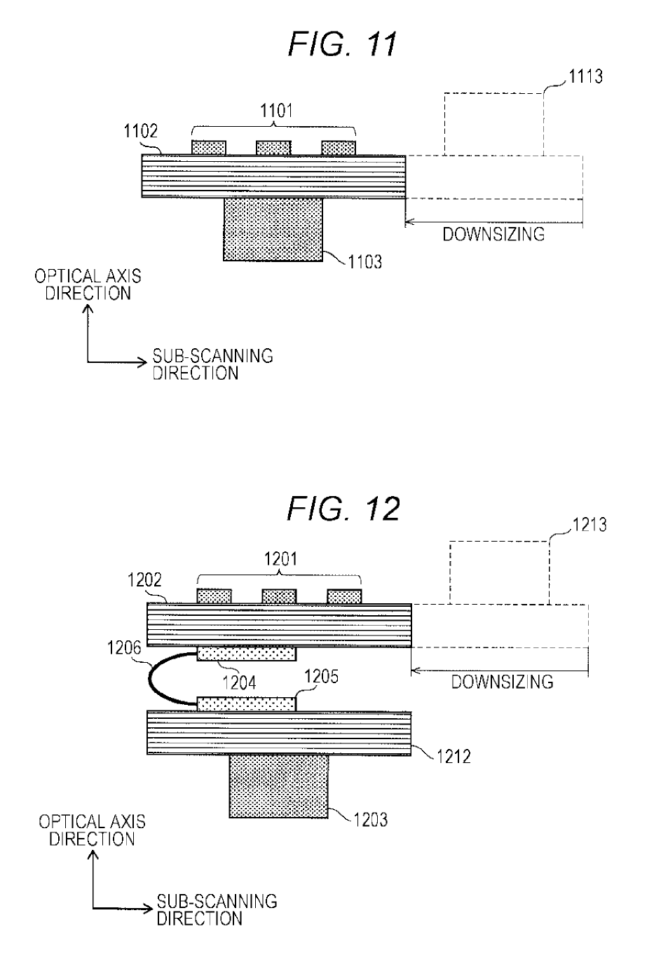

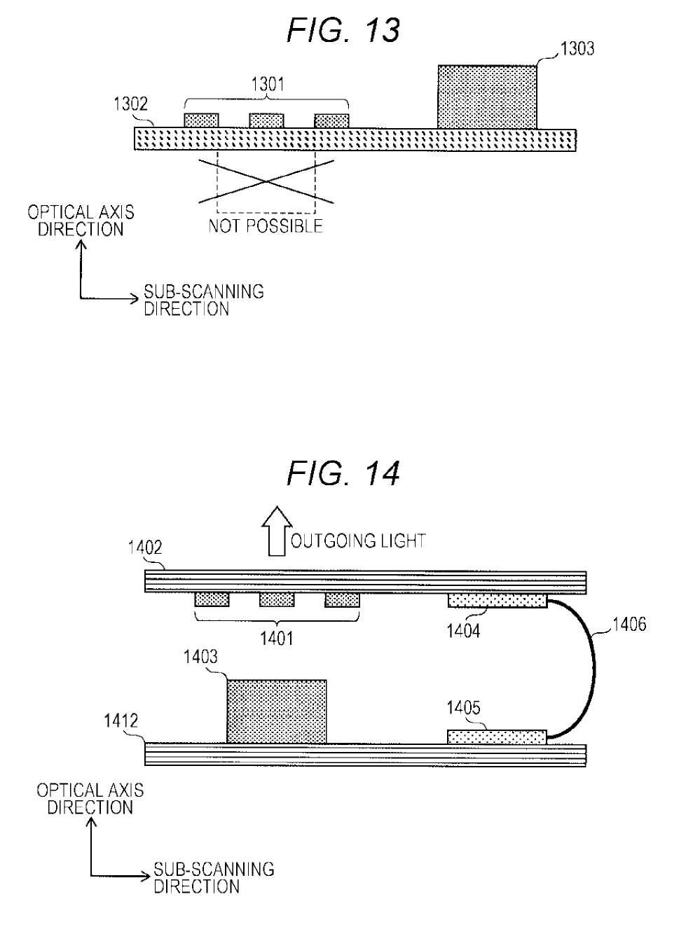

As illustrated in FIG. 9, a light source substrate 900 according to the present embodiment includes a daughter board 900a and a mother board 900b. In the daughter board 900a, a light emitting point group 901a and driver ICs 903a1 and 903a2 are mounted on the substrate surface opposite to the optical element 210 in the optical axis direction of a glass substrate 902a, and the light emitting point group 901a is sealed by a sealing glass 904a. A flat upper portion of the sealing glass 904a is adhesively fixed to the substrate surface on the optical element 210 side in the optical axis direction of the mother board 900b.

In the mother board 900b, light emitting point groups 901b1 and 901b2, and driver ICs 903b1 and 903b2 are mounted on the substrate surface opposite to the optical element 210 in the optical axis direction of a glass substrate 902b, and the light emitting point groups 901b1 and 901b2 are respectively sealed by sealing glasses 904b1 and 904b2. The daughter board 900a is disposed on the optical element 210 side of the mother board 900b.

In the light source substrate 900, the light emitting point group 901a and the driver ICs 903a1 and 903a2 are disposed to overlap the driver ICs 903b1 and 903b2, when viewed from the optical axis direction. Among them, since the light emitting point group 901a is disposed on the optical element 210 side of the driver ICs 903a1 and 903a2, the outgoing light of the light emitting point group 901a is incident on the optical element 210 without being blocked by the driver ICs 903a1 and 903a2. In this way, since it is possible to simulatively multilayer the light source substrate 900, it is possible to reduce the size of the light source substrate 900 in the sub-scanning direction.

Also, the light source substrate 900 is formed such that a symmetrical shape is formed about the center in the sub-scanning direction, by interweaving a portion having a relatively short distance and a portion having a long distance from the light emitting point to the photosensitive drum 101. In other words, a plurality of regions, on which the light emitting point group is mounted, are provided in the sub-scanning direction, and in the plurality of regions, distances in the optical axis direction from the light emitting point groups mounted in the regions to the outer peripheral surface of the photosensitive drum 101 are different from each other. In this way, even if the light emitting point generates heat by turning on the light emitting point, it is possible to suppress distortion of the light source substrate 900 due to the temperature rise.

### [6] Modification

Hereinbefore, the present invention is described based on the embodiments. However, it is needless to say that the present invention is not limited to the above embodiments. Therefore, it is possible to implement the following modifications.

(6-1) In the first embodiment and the third to fifth embodiments, there have been described cases where the light source substrate is disposed such that the substrate surface of the glass substrate is orthogonal to the optical axis direction by way of example. However, needless to say, the present invention is not limited thereto. In the first embodiment and the third to fifth embodiments as well, the light source substrate may be disposed such that the substrate surface obliquely intersects the optical axis direction, as in the second embodiment. In this way, as in the second embodiment, it is possible to reduce the size of the light source substrate in the sub-scanning direction in plan view from the optical axis direction.
(6-2) In the second to fifth embodiments, there have been described cases where the light emitting point group is mounted only on one substrate surface of the glass substrate by way of example. However, the present invention is not limited thereto. Therefore, needless to say, in the second to fifth embodiments as well, the light emitting point group may be mounted on both the substrate surfaces of the glass substrate, as in the first embodiment.

In this way, since, in the second embodiment, the driver ICs can be disposed at positions overlapping each other in plan view from the direction orthogonal to the substrate surface, it is possible to further reduce the size of the light source substrate in the sub-scanning direction. Also, since, in the third to fifth embodiments, it is possible to reduce the number of glass substrates, it is possible to reduce the size of the light source substrate in the optical axis direction and it is possible to reduce the component cost of the glass substrate.

(6-3) In the embodiments, there have been described the cases where the image forming apparatus is a tandem type color printer by way of example. However, needless to say, the present invention is not limited thereto. Instead of this tandem type color printer, the image forming apparatus may be another type color printer or a monochrome printer. Also, even if the present invention is applied to a single function machine such as a copier having a scanner or a facsimile machine further having a facsimile communication function, or a multi-function peripheral (MVP) having these functions, it is possible to obtain the same effect.

The optical writing device and the image forming apparatus according to the present invention are useful as an apparatus in which a line optical type optical writing device is downsized.

According to an embodiment of the present invention, it is possible to achieve both high definition of the image and reduction of the unit size in the sub-scanning direction, in this way.

Although embodiments of the present invention have been described and illustrated in detail, the disclosed embodiments are made for purposes of illustration and example only and not limitation. The scope of the present invention should be interpreted by terms of the appended claims

What is claimed is:

1. An optical writing device comprising:
a light source substrate in which a plurality of light sources and a driving circuit for driving the plurality of light sources are mounted on the same substrate surface; and
an optical element that images outgoing light of the light sources on a photoreceptor,
wherein the plurality of light sources are two-dimensionally disposed in plan view from an optical axis direction of the optical element, and
the light sources having distances different from each other in the optical axis direction to the photoreceptor are included.

2. The optical writing device according to claim 1,
wherein the plurality of light sources form a plurality of light source arrays in which light source arrays in which light sources are disposed along a first direction are disposed side by side in a second direction different from the first direction, and
the light sources having distances different from each other in the optical axis direction to the photoreceptor are included in light source arrays different from each other.

3. The optical writing device according to claim 2,
wherein the light sources belonging to light source arrays different from each other have distances different from each other in the optical axis direction to the photoreceptor.

4. The optical writing device according to claim 1,
wherein the light source substrate includes a plurality of unit substrates in which a plurality of light sources and a driving circuit for driving the plurality of light sources are mounted on the same substrate surface, and
the light sources having distances different from each other in the optical axis direction to the photoreceptor are mounted on unit substrates different from each other.

5. The optical writing device according to claim 4,
wherein a light source mounted on one unit substrate and a region, in which a light source on another unit substrate far from the optical element as compared with the one unit substrate is not mounted, overlap each other in plan view from the optical axis direction.

6. The optical writing device according to claim 4,
wherein, in plan view from the optical axis direction, the unit substrates overlap each other in a region where a light source is not mounted.

7. The optical writing device according to claim 4,
wherein a plurality of regions, on which light sources are mounted, are provided in a direction different from a first direction, and
in the plurality of regions, distances in the optical axis direction from a light source mounted in the regions to the photoreceptor are different from each other.

8. The optical writing device according to claim 4,
wherein the plurality of unit substrates include a two-dimensional array substrate in which the light sources are two-dimensionally disposed, and
a light source mounted on a unit substrate close to the optical element as compared with the two-dimensional array substrate is interposed between the light sources mounted on the two-dimensional array substrate, in plan view from the optical axis direction.

9. The optical writing device according to claim 4, further comprising:
a holder that holds the plurality of unit substrates in order not to be in contact with each other.

10. The optical writing device according to claim 1,
wherein light sources having different distances from each other in the optical axis direction to the photoreceptor are mounted on substrate surfaces different from each other of one substrate.

11. The optical writing device according to claim 1,
wherein the light source substrate is disposed such that a substrate surface obliquely intersects the optical axis direction.

12. The optical writing device according to claim 1,
wherein the light sources are a light emitting point group including a plurality of light emitting points.

13. The optical writing device according to claim 1,
wherein the light sources are an OLED.

14. An image forming apparatus comprising
the optical writing device according to claim 1.
